(19) United States
(12) Patent Application Publication
(10) Pub. No.: US 2005/0178771 A1
(43) Pub. Date: Aug. 18, 2005

(54) Container with luminescent features

(76) Inventor: Jorge E. Moran, Nashville, TN (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/059,623

(22) Filed: Feb. 17, 2005

Related U.S. Application Data
(60) Provisional application No. 60/544,500, filed on Feb. 17, 2004.

(51) Int. Cl. F25D 3/08; A47J 41/00

(52) U.S. Cl. 220/592.16

(57) ABSTRACT

A container has several components which can be manufactured from plastic with a luminescent pigment incorporated in the plastic, or a luminescent pigment can be incoporated into a plastic material and used as a coating on certain portions or features of a container. The luminescent feature assists the user in identifying and retrieving the container in low light conditions. The luminescent feature may also communicate information about the container to the user through visual cues. For example, a luminescent coating on one portion of a container may signal that a cup or stopper is not attached to the container.

### BACKGROUND

The present invention relates to the field of portable beverage and food storage containers.

Many types of portable beverage storage containers exist which allow persons to transport and store beverages or foods. Some of these containers are vacuum insulated to help maintain the beverage or food at a desired temperature. In some areas of the world there are a large number of households which depend upon these portable containers to store perishable items. When a refrigerator is not present in the household these containers play a vitally important role in storing important, perishable beverages and foods. For example, some households depend upon these containers for storing milk for babies and young children that must be maintained in a clean container and at a cool temperature to preserve the milk.

Many of these households that depend upon these containers in the manner described above also do not have electricity or, at least, do not have a large amount of ambient light at night. If the user wishes to locate the container during the night to, for example, give milk to a baby or young child, it may be difficult to locate the container in the darkness.

Likewise, a user may keep a personal, portable beverage or food container in a vehicle for comsuption of the beverage or food in the vehicle during a trip. At night, it may be difficult to locate and retrieve the container if the interior of the vehicle is not well lit. Locating and retrieving the container can be especially cumbersome if the user is operating the vehicle and cannot divert his attention from operating the vehicle in order to intently search for the container.

The present invention is directed to overcoming these and similar problems with the use of personal, portable beverage and food containers. The present invention is directed towards assisting users in quickly finding and identifying these containers in low light or very dark conditions. The container of the present invention provides a unique combination of features and construction which enhances the containers usability, permits the container to be manufactured in a cost effective manner, and provides the user with a visually appealing, attractive, and durable product.

### BRIEF DESCRIPTION OF THE DRAWINGS

FIG. 1 is an isometric view of an exemplary embodiment of a container according to the invention with the stopper 40 and cup 30 attached to a flask 21.

FIG. 2 is an exploded view of the container of FIG. 1, with the stopper 40 and cup 30 removed from the flask 21.

FIG. 3 illustrates a sectional view of another exemplary container taken along a cutting plane parallel to the central axis of the flask 21.

### DETAILED DESCRIPTION OF THE INVENTION

The principles of the invention will be described through reference to particular embodiments of the invention illustrated in the drawing figures. The principles of the invention may be used to create other embodiments that will differ from the illustrated embodiments in order to suit particular needs, but that will nonetheless fall within the scope of the invention. The scope of the invention is intended to be defined in the appended claims.

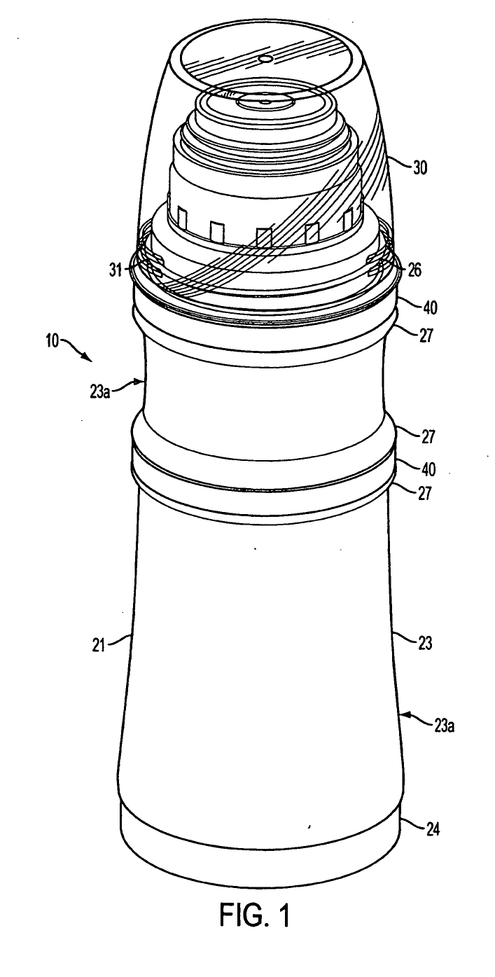

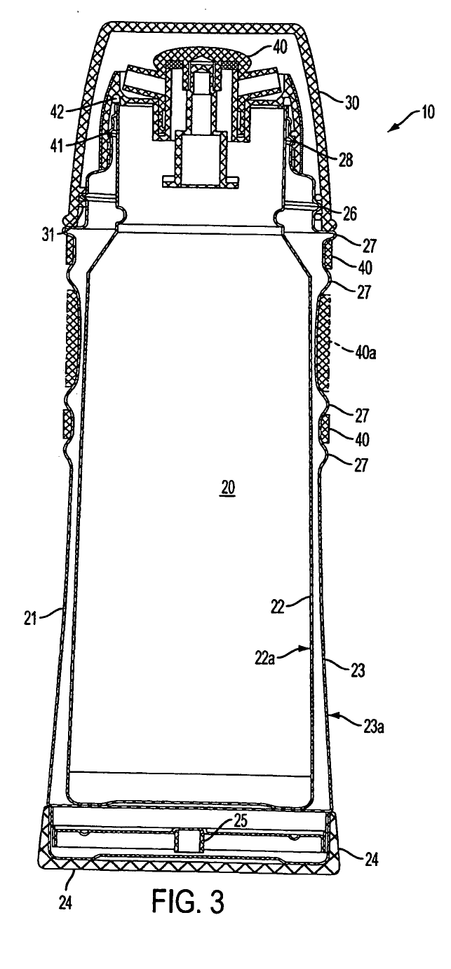

FIGS. 1-3 illustrate a container 10 that exemplifies containers that can benefit from the principles of the invention. As seen in FIG. 3, the container 10 includes a vacuum insulated main chamber 20. The main chamber 20 is defined by flask 21. Flask 21 also defines an opening for dispensing the beverage from the main chamber 20. The flask 21 may be vacuum insulated in a known manner, as illustrated, to help maintain the temperature of the beverage or food contained in the main chamber 20. In FIGS. 1-3, the flask is formed by an interior shell 22 and an exterior shell 23, with an interior surface 22a formed on the interior shell 22, and an exterior surface 23a formed on the exterior shell 23. A vacuum insulated space resides between the interior shell 22 and the exterior shell 23. In other embodiments, the flask 21 need not be vacuum insulated.

The flask 21 can be made of stainless steel for durability and easy maintenance, or other metallic materials such as aluminum or titanium. The flask could also be made from plastic materials (if it is not vacuum insulated) or glass. In the embodiments in FIGS. 1-3, the exterior surface 23a of the flask 21 is exposed. In other embodiments, the flask 21 may be enclosed by an exterior covering, as is known in the art. The exterior covering may be a plastic shell.

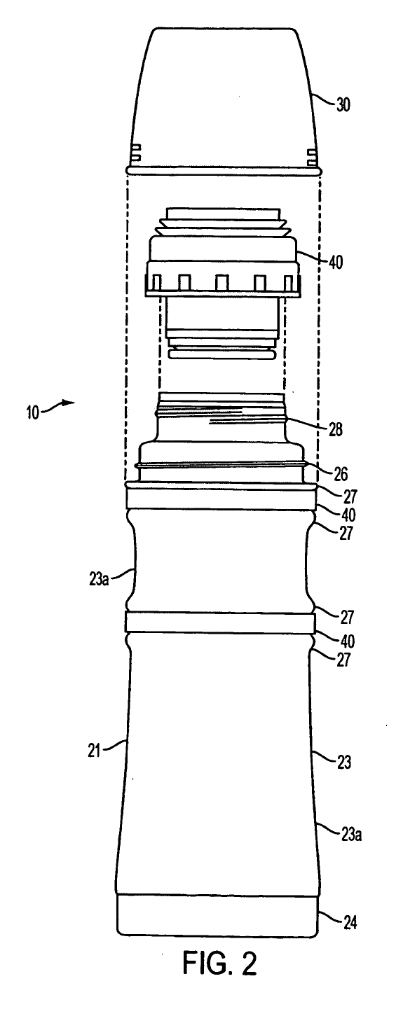

The flask 21 has a bottom cap 24 attached to the bottom. The bottom cap 24 has a smooth, flat bottom surface to facilitate the container 10 being placed on a table top, and to facilitate handling of the container 10. The bottom of flask 21 includes a port 25 used in the vacuum insulating of the flask. The port 25 can often include rough edges or protruding surfaces. The port 25 is advantageously covered by the bottom cap 24, along with other surfaces on the bottom of flask 21 which may have rough edges or protrusions. As illustrated in FIG. 3, bottom cap 24 can be injection molded from plastic and bonded to the flask 21 in a known manner. Or, as illustrated in FIGS. 1 and 2, the bottom cap can be made of stainless steel and bonded to the flask 21 in a known manner.

The top of flask 21 includes threads and other attachment means for attaching a cup 30, and a stopper 40. In the illustrated embodiment, flask 21 provides threads 26 on the exterior shell 23 for attaching the cup 30. Cup 30 has mutual threads 31 that mate with threads 26 to hold cup 30 on the container 10 for storage. The cup 30 can advantageously be injection molded from plastic, and may or may not include a handle to facilitate grasping by the user. The cup 30 can be made especially visually appealing if it is made from a transparent plastic material.

Stopper 40 closes the opening in the main chamber 20 to retain the beverage, and includes means for opening the main chamber so that the beverage can be dispensed. Any suitable stopper can be used for these purposes. Threads 28 can be formed directly on the exterior shell 23 of flask 21 for attaching stopper 40. Stopper 40 includes mating threads 41 that engage with threads 28 to hold the stopper on the flask 21. A seal 41 may also be used between the flask 21 and stopper 40 to ensure the retention of the beverage by preventing leaks. A “pop-up” valved stopper is shown employed in FIGS. 1 and 2. A two-spouted pull-up stopper is shown employed in FIG. 3.

Elastomeric bands 40 can be included on the exterior surface 23a of flask 21 to assist the user in gripping the container 10. Elastomeric bands 40 can be made from any appropriate elastomeric material, such as PVC. Elastomeric bands 40 provide an area of increased friction where the user's fingers can form a stronger hold on the container 10.

To protect the elastomeric bands 40 and to assist in their proper placement on the container 10 during manufacture, they can be situated between raised ridges 27 on the exterior shell 23 of flask 21. The raised ridges 27 can be formed on each side of each elastomeric band 40. The raised ridges 27 are raised from the profile of the immediately surrounding exterior surface 23a by a height equal to or greater than the thickness of the elastomeric bands 40. The ridges 27 can be formed inexpensively as an integral part of the exterior shell 23 of flask 21. The raised ridges 27 are formed by bending of the material used in manufacturing the exterior shell 23. The thickness of the exterior shell 23 is approximately the same at the raised ridges 27 as the thickness at other portions of the exterior shell, i.e. the thickness of the exterior shell 23 is approximately uniform throughout.

The raised ridges 27 help keep the elastomeric bands 40 in position and help protect the bands from wear, scratches, and tears. The elastomeric bands 40 are made from an elastomeric material to increase their friction against a user's fingers. However, as a result the elastomeric bands 40 may not be as durable as is desirable, so the raised ridges 27 perform an important function in protecting the bands.

Two elastomeric bands 40 are shown in FIGS. 1-3. More or fewer elastomeric bands 40 may also be used, as desirable for a particular container. For example, a wider elastomeric band 40a, shown outlined in FIG. 3, could be included instead of, or in addition to, the two thinner elastomeric bands 40.

In order to assist the user in identifying and retrieving the container 10 in low light conditions, one or more of the parts of the container can be made with materials having luminescent properties, or one or more of the components of the container can be coated with a material having luminescent properties. The luminescent feature or features of the container 10 will emit light which can be detected by the user in low light conditions to help identify the container, or even to convey some information about the container.

Various luminescent pigments in powder and other forms are currently commercially available which are designed to be mixed with plastic material and formed into parts through extrusion, casting, injection molding processes, etc. In a known manner, these luminescent pigments absorb energy from light. The absorbed energy is later expended in a dark environment when the energy is converted into emitted light and the pigment glows. The pigment, combined with the plastic material, can produce parts which “glow-in-the-dark.” The plastic material can include PVC, PE, PP, EVA, or ABS, among other possibilities. Several formulations of the luminescent pigments are commercially available and an exact description of the chemical formulas of the various pigments which are available is not necessary. The commercially available luminescent pigments can be surveyed and one or more can be selected to meet a particular application's requirements such as color, toxicity, durability, lifespan, compatibility with the plastic material, etc.

In one embodiment, the elastomeric bands 40 can be constructed from PVC with the luminescent pigment incorporated into the PVC during the manufacturing process. The elastomeric bands 40 will the glow in low light environments, producing a distinctive lighted pattern on the container 10 which permits easy identification and retrieval. The addition of the luminescent pigment makes the elastomeric bands 40 incrementally more expensive to manufacture. However, because the elastomeric bands 40 are relatively small compared to the container 10 as a whole, incorporating the luminescent pigment in the elastomeric bands 40 is less expensive than incorporating the pigment into larger components of the container 10.

The luminescent pigment may also be incorporated into other components of the container 10. The bottom cap 24 may be constructed of a plastic material, as in FIG. 3, with the luminescent pigment incorporated therein. Likewise, the stopper 40 and the cup 30 may be constructed of a plastic material with the luminescent pigment incorporated therein. The cup 30 can be especially visually appealing when constructed from a transparent material with the luminescent pigment incorporated therein. The components of the container 10 which should incorporate the luminescent pigment can be selected according to the particular application and the user's preferences.

The luminescent pigment can also be combined with a plastic material and applied to components of the container 10 as a film or coating. In this manner, metal components such as the exterior surface 23a of stainless steel flask 21 can be coated with a luminescent coating. Coatings permit a high degree of flexibility in the portion of the container 10 to which the luminescent material is applied. Thus, complex and attractive patterns can be created by coating a component of the container 10.

Besides the purpose of assisting in identification and retrieval of container 10 in low light conditions, a luminescent feature may communicate valuable information to the user. For example, in the container in FIG. 3, the threads 26, or a portion of the exterior shell 23 in the vicinity of the threads 26, may be coated with a luminescent material. When the cup 30 is attached to the flask 21, the luminescent material would be covered and invisible (assuming the cup 30 is opaque). In low light conditions, if the luminescent material is visible this would serve as a visual cue to a user that the cup 30 is not attached. Likewise, the threads 41, or a portion of the flask 21 in the vicinity of the threads 41, may be coated with the luminescent coating so that the visibility of the coating signals to a user that the stopper 40 is not attached to the flask 21. This could serve as a useful reminder in cases where the container needs to be closed to guard the contents from contamination, or when the stopper needs to be attached to insulate the contents of the container.

A luminescent coating on the bottom cap 24, or forming the bottom cap 24 with the luminescent pigment, can serve as a visual cue to the user that the container has been tipped over or is on its side.

A luminescent coating, or a luminescent portion forming part of the container 10, can provide a visual cue to a user of the location of a handle or other feature that might be incorporated into the design of the container.

Although the invention has been described through a description of a particular arrangement of components in embodiments, those in the art will recognize that various modifications and variations can be made without departing from the spirit or scope of the invention. The foregoing descriptions are illustrative only and are not intended to limit the scope of the invention in any way. The scope of the invention shall be defined by the appended claims.

1. A container for holding food or beverages comprising:
a flask defining a main chamber with an opening in the top of flask for accessing the main chamber, the flask having an exterior surface that a user can grip when holding the container; and
an elastomeric band situated on the exterior surface of the flask and extending circumferentially around the flask, the elastomeric band comprising a luminescent pigment.
